(19) United States
(12) Patent Application Publication
(10) Pub. No.: US 2008/0137106 A1
(43) Pub. Date: Jun. 12, 2008

(54) METHOD FOR DETERMINING THE THICKNESS OF PHOSPHOR LAYER AND METHOD FOR MANUFACTURING LIGHT EMITTING APPARATUS

(75) Inventor: Takashi ONO, Onomichi-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 11/952,795

(22) Filed: Dec. 7, 2007

(30) Foreign Application Priority Data
Dec. 11, 2006 (JP) 2006-333540

(51) Int. Cl. G01B 11/28; H01J 9/02

(52) U.S. Cl. 356/630; 445/50

(57) ABSTRACT

A method for determining a thickness of a phosphor layer of a device having the phosphor layer formed by dispersing phosphor particles in a transparent resin, comprising the steps of: applying laser light to the phosphor layer to determine the thickness of the phosphor layer based upon an area of a light emitting region or a light emission intensity of fluorescence excited from the phosphor particles by the laser light.

### CROSS-REFERENCE TO RELATED APPLICATION

This application is related to Japanese Patent Application No. 2006-333540 filed on Dec. 11, 2006, whose priority is claimed and the disclosure of which is incorporated by reference in its entirety.

### BACKGROUND OF THE INVENTION

1. Field of the Invention

The present invention relates to a method for determining a thickness of a phosphor layer and a method for manufacturing a light emitting apparatus. More specifically, this invention relates to a method for determining a thickness of a phosphor layer of a device that is provided with a phosphor layer, and a method for manufacturing a light emitting apparatus that is allowed to emit light having a specific color by surrounding a periphery of a light emitting diode chip with the phosphor layer.

2. Description of the Related Art

A light emitting diode (hereinafter, sometimes referred to as an LED) is used for a light emitting diode display apparatus, a backlight light source for a liquid crystal display apparatus and the like. In recent years, a precipitation-type white LED, in which yellow phosphor particles that emit yellow light by absorbing blue light are precipitated on the periphery of a blue LED to obtain white light, has been produced.

As shown in FIG. 1, such a precipitation-type white LED 6 has a structure, in which a package 2, formed by a transparent resin material into a rectangular parallelepiped having a concave section on an upper face to form an upper opening, is attached onto a substrate 1, and a blue LED chip 3 is placed on a center of a bottom face of the concave section of the package 2.

A sealing material, formed by mixing yellow phosphor particles with a transparent thermosetting resin such as an epoxy resin and a silicone resin, is injected quantitatively into the concave section by using a filling device (for example, an air dispenser) and thermally cured, so that a sealing layer is formed. This sealing layer is composed of a phosphor layer 4 formed by precipitating yellow phosphor particles so as to completely cover the blue LED chip 3 and a transparent resin layer 5 on the phosphor layer 4. In the precipitation-type white LED, a determination of chromaticity is greatly attributed to a thickness of the phosphor layer 4.

Here, in the precipitation-type white LED, although not shown in the Figures, electrodes are attached to a bottom face and an upper face of the blue LED chip, with positive and negative electrodes being placed on right and left side faces of the package. The bottom-face electrode is connected to the electrode through a wire inserted into a hole penetrating the substrate, and the upper-face electrode is wired through a wire stretched from the upper face of the chip to the substrate. Moreover, another precipitation-type white LED has been proposed in which positive and negative electrodes, which are wired through two wires, are placed on the upper face of the chip.

A light emitting apparatus has been publicly known, as still another precipitation-type white LED, in which, for example, a mixture of a plurality of kinds of phosphor particles having mutually different light emission colors and a transparent thermosetting resin is poured into a LED chip placed on the bottom face of the concave section of the package so that the resin is thermally cured, with the phosphor particles being precipitated thereon (see JP-A No. 2006-100730).

In the injecting process of the sealing material by the use of a filling device such as an air dispenser, as an amount of the sealing material in the syringe reduces, a pressure to be applied to the sealing material in the syringe is gradually lowered. Therefore, an amount of injection of the sealing material to be successively injected to a plurality of packages gradually reduces. Consequently, difference occurs in the thickness of the phosphor layer for every package to which the sealing material is injected, and a light emitting apparatus that is out of reference chromaticity tends to be produced. Moreover, in the filling device that injects the sealing material quantitatively, precipitation of yellow phosphor particles progresses. Therefore, although a mixing ratio between the amount of the resin and the amount of the phosphor particles has been set to a constant value, the amount of the phosphor particles gradually changes for every package to which the sealing material is injected. Consequently, the differences occur in the thickness of the phosphor layer for every light emitting apparatus, and the light emitting apparatus that is out of the reference chromaticity is consequently produced.

Here, a plurality of white LED's successively produced are regarded as having respective phosphor layers with desired thicknesses, and no inspection process for measuring the actual thickness of the phosphor layer to confirm whether or not the desired thickness is maintained is carried out.

### SUMMARY OF THE INVENTION

The present invention has been devised so as to solve these problems, and its object is to provide a method for determining a thickness of a phosphor layer of a light emitting apparatus that can restrain differences (deviations) in chromaticity in the light emitting apparatus having a phosphor layer precipitated on the periphery of a LED element and consequently improve a yield, and a method for manufacturing such a light emitting apparatus.

In accordance with one aspect, the present invention provides a method for determining a thickness of a phosphor layer of a device having the phosphor layer formed by dispersing phosphor particles in a transparent resin, comprising the step of: applying laser light to the phosphor layer to determine the thickness of the phosphor layer based upon an area of a light-emitting region or a light emission intensity of fluorescence excited from the phosphor particles by the laser light.

Moreover, in accordance of another aspect, the present invention provides a method for manufacturing a light emitting apparatus, comprising the steps of: placing a light emitting diode chip on a bottom face of a concave section of a package; injecting a sealing material prepared by mixing phosphor particles with a transparent resin into the concave section; and forming a sealing layer by curing the transparent resin with the phosphor particles in a precipitated state so as to completely cover the light emitting diode chip, wherein, by using the method for determining a thickness of the phosphor layer, an area of a light emitting region or the light emission intensity of each of phosphor layers of a reference light emitting apparatus having reference chromaticity and an arbitrarily selected light emitting apparatus to be inspected is measured; an amount of change in the light emission area or the light emission intensity of the light emitting apparatus to be inspected relative to the light emission area or the light emission intensity of the reference light emitting apparatus is calculated; and the amount of change is returned to the injecting step to adjust injecting conditions and subsequently adjust the amount of injection of the sealing material to be injected to the package, so that the thickness of the phosphor layer is adjusted so as to set the chromaticity of the light emitting apparatus to the reference chromaticity.

In accordance with the method for determining the thickness of the phosphor layer of the present invention, the thickness of the phosphor layer in an arbitrarily selected device can be determined easily without breakage.

Moreover, in accordance with the method for manufacturing the light emitting apparatus of the present invention, it becomes possible to restrain difference in chromaticity of a manufactured light emitting apparatus, and consequently to improve the yield.

### BRIEF DESCRIPTION OF THE DRAWINGS

FIG. 1 is a cross-sectional view of a general precipitation-type white LED;

FIG. 2 is a block diagram that shows a method for manufacturing a light emitting apparatus in accordance with one embodiment of the present invention;

FIG. 3 is a drawing that explains an installation method for a semiconductor line laser in accordance with one embodiment;

FIG. 4 is a drawing that explains laser light proceeded into a yellow phosphor layer in accordance with one embodiment;

FIG. 5 is a drawing that explains a state in which the yellow phosphor layer is thicker than that of FIG. 4;

FIGS. 6A and 6B are drawings that explain a difference in fluorescence width caused by the thickness of the yellow phosphor layer in accordance with one embodiment;

FIGS. 7A and 7B are drawings that explain a difference in fluorescence length caused by the thickness of the yellow phosphor layer in accordance with one embodiment;

FIG. 8 is a drawing that explains a measuring method for a phosphor area in accordance with one embodiment; and

FIG. 9 is a drawing that explains the relationship between the results of measurements on the thickness of the yellow phosphor layer by the present measuring method and the chromaticity in accordance with one embodiment.

### DESCRIPTION OF THE PREFERRED EMBODIMENTS

The present invention is a method for determining a thickness of a phosphor layer of a device having the phosphor layer formed by dispersing phosphor particles in a transparent resin, including the steps of: applying laser light onto the phosphor layer to determine the thickness of the phosphor layer based upon an area of a light-emitting region or a light emission intensity of fluorescence excited from the phosphor particles by the laser light.

This determination refers to a determining process that is made as to whether the thickness of the phosphor layer to be measured is thicker or thinner in comparison with a certain reference.

More specifically, in the present invention, upon quantitatively evaluating the thickness of the phosphor layer of the device having the phosphor layer, first, laser light is diagonally applied to a reference phosphor layer of a reference device manufactured by using a manufacturing device in the actual manufacturing site, as described above, to generate fluorescence (diffused light) excited from the phosphor, and an area (light emission area) of a light emitting region of fluorescence when viewed in a direction perpendicular to the surface of the phosphor layer or a light emission intensity of fluorescence is measured.

With respect to the device to be used for the method for determining a thickness of a phosphor layer of the present invention, for example, a precipitation-type light emitting apparatus, which has a package having a concave section, a light emitting diode chip placed on the bottom face of the concave section of the package and a sealing layer formed by injecting a sealing material formed by mixing phosphor particles in a transparent resin into the concave section to be cured therein, with the sealing layer being provided with the phosphor layer covering the light emitting diode chip and a transparent resin layer on the phosphor layer, is preferably used.

This precipitation-type light emitting apparatus has a structure, in which the phosphor particles are allowed to absorb one portion of a wavelength of light emission from the light emitting diode chip to emit light with specific chromaticity, and the light emitting diode chip and the phosphor particles can be selected on demand so as to obtain desired chromaticity. Therefore, although the light emitting diode chip and the phosphor particles are not particularly limited, the primary particle size of the phosphor particles is preferably set in a range from 10 to 13 μm. Here, a thermosetting resin or a photocurable resin, which is capable of setting precipitated phosphor particles into a layer with a fixed thickness, and has superior productivity, is preferably used as the transparent resin.

The following description will discuss the method for determining a thickness of a phosphor layer by exemplifying the light emitting apparatus of this kind.

In the method for determining a thickness of a phosphor layer of the light emitting apparatus, first, by using a reference light emitting apparatus having reference chromaticity (designed chromaticity) manufactured by using the same filling device as that used in the actual manufacturing site, laser light is diagonally applied to the phosphor layer thereof to generate fluorescence as described above. Thus, the light emission area or the light emission strength of the fluorescence, when viewed in a direction perpendicular to the surface of the transparent resin layer on the upper portion of the sealing layer, is measured. At this time, the reference light emitting apparatus refers to such an apparatus as to have a phosphor layer having a reference thickness (designed thickness) used for emitting light with reference chromaticity. Here, the chromaticity-measuring process of the reference light emitting apparatus may be carried out by using a known chromaticity-measuring device.

A semiconductor laser is preferably used as a laser light source used for applying laser light to the phosphor layer. In this case, the laser light has a linear shape, and is formed into parallel light rays by using a condensing lens or the like, if necessary. Moreover, in the case when the laser light has a beam diameter that is applied over a range wider than at least a width of the phosphor layer (width of the laser light in a direction perpendicular to the light-releasing direction of the laser light), preferably, over a range wider than the width in the same direction of the package, the laser light can be applied with the laser light source standing still; however, in the case when the beam diameter is smaller than the above-mentioned range, the releasing direction of the laser light is changed in its direction by parallel-shifting or rocking the laser light source, so that the light emitting face of fluorescence, viewed on its plane, may be scanned.

In the irradiation with laser light, a travel distance of the laser light passing through the phosphor layer is varied depending on the thickness of the phosphor layer. In other words, in the case when the thickness of the phosphor layer is thick, the light-emitting area of the fluorescence becomes larger because of the long distance over the phosphor layer through which the laser light passes, and the light emission intensity becomes smaller because of the increased diffusion in the laser light, in comparison with the phosphor layer with a thinner thickness. In this manner, since the light-emitting area and the light emission intensity of the fluorescence are parameters that depend only on the thickness of the phosphor layer, the light-emitting area or the light emission intensity can be utilized in place of the thickness of the phosphor layer, without the necessity of directly measuring the thickness of the phosphor layer of the light emitting apparatus; alternatively, both of the light-emitting area and the light emission intensity may be measured. Here, as described above, the chromaticity of the light emitting apparatus also depends on the thickness of the phosphor layer.

With respect to the method for measuring the light-emitting area or the light emission intensity, for example, a phosphor image is picked up by using an image-processing device with an image-pickup apparatus (for example, a monochrome image-pickup CCD camera) placed right above the light emitting apparatus, and the resulting image is image-processed so that the light-emitting area or the light emission intensity can be calculated. This method will be described later in detail.

By arbitrarily selecting a light emitting apparatus (hereinafter, referred to as a light emitting apparatus to be inspected) from a plurality of light emitting apparatuses manufactured by using the same filling device at the same manufacturing site as described above. Similarly, laser light is diagonally applied to the phosphor layer of this light emitting apparatus to be inspected to generate fluorescence thereon, and the light-emitting area or the light emission intensity of fluorescence, viewed in a direction perpendicular to the surface of the transparent resin layer on the upper portion of the sealing layer, is measured.

Moreover, by comparing the light-emitting area or the light emission intensity of the light emitting apparatus to be inspected with that of a reference light emitting apparatus, it becomes possible to determine whether the thickness of the phosphor layer of the light emitting apparatus to be inspected is thicker or thinner than the thickness of the phosphor layer of the reference light emitting apparatus.

That is, in the case when the light-emitting area of the light emitting apparatus to be inspected is larger than that of the reference light emitting apparatus, the thickness of the phosphor layer of the light emitting apparatus to be inspected is determined to be thicker than that of the reference light emitting apparatus. However, in the case when the light-emitting area of the light emitting apparatus to be inspected is smaller than that of the reference light emitting apparatus, the thickness of the phosphor layer of the light emitting apparatus to be inspected is determined to be thinner than that of the reference light emitting apparatus. Alternatively, in the case when the light emission intensity of the light emitting apparatus to be inspected is higher than that of the reference light emitting apparatus, the thickness of the phosphor layer of the light emitting apparatus to be inspected is determined to be thinner than that of the reference light emitting apparatus. However, in the case when the light emission intensity of the light emitting apparatus to be inspected is lower than that of the reference light emitting apparatus, the thickness of the phosphor layer of the light emitting apparatus to be inspected is determined to be thicker than that of the reference light emitting apparatus. This determination corresponds to a determination as to whether or not the chromaticity of the light emitting apparatus to be inspected is set to the reference chromaticity.

By the above-mentioned determination, an amount of change corresponding to a difference between the light-emitting area or the light emission intensity of the light emitting apparatus to be inspected and that of the reference light emitting apparatus (=value of the reference light emitting apparatus—value of the light emitting apparatus to be detected), that is, an amount of change as to how thick or how thin the thickness of the phosphor layer of the light emitting apparatus to be inspected is in comparison with that of the reference light emitting apparatus, can be calculated, and this amount of change can be utilized for a method for manufacturing a light emitting apparatus, which will be described later.

The method for manufacturing the light emitting apparatus of the present invention includes the steps of: placing a light emitting diode chip on the bottom face of a concave section of a package; injecting a sealing material formed by mixing phosphor particles with a transparent resin into the concave section; and forming a sealing layer by curing the transparent resin with the phosphor particles in a precipitated state so as to completely cover the light emitting diode chip, and is characterized that, by using the method for determining a thickness of the phosphor layer, the light emission area or the light emission intensity of each of the phosphor layers of a reference light emitting apparatus having reference chromaticity and a desirably selected light emitting apparatus to be inspected is measured; an amount of change in the light emission area or the light emission intensity of the light emitting apparatus to be inspected relative to the light emission area or the light emission intensity of the reference light emitting apparatus is calculated; and the amount of change is returned to the injecting step to adjust the injecting conditions and subsequently adjust the amount of injection of the sealing material to be injected to the package, so that the thickness of the phosphor layer is adjusted so as to set the chromaticity of the light emitting apparatus to the reference chromaticity.

In general, upon manufacturing the light emitting apparatus having the above-mentioned construction, the sealing material is successively injected into the packages by using a filling device, such as an air dispenser. in this case, as the sealing material inside the syringe reduces, the pressure to be applied to the sealing material inside the syringe is gradually lowered. Therefore, the amount of injection of the sealing material to be injected into the packages gradually reduces. Thus, differences in thickness of the phosphor layer occur for every package, resulting in differences in chromaticity.

In the method for manufacturing the light emitting apparatus of the present invention, by feeding back the above-mentioned amount of change to the injecting process as described above, the amount of injection of the sealing material to be injected to the packages is adjusted so as to maintain a predetermined amount. As a result, the difference in thickness and differences in chromaticity of the phosphor layer of the light emitting apparatus thus manufactured can be restrained. More specifically, the amount of injection is adjusted in the following manner.

In the case when the amount of change in the light-emitting area of the light emitting apparatus to be inspected is a positive (plus) value, since this state means that the thickness of the phosphor layer is too thick, the amount of injection of the sealing material is adjusted and reduced in accordance with the amount of change; in contrast, in the case when the amount of change is a negative (minus) value, since this state means that the thickness of the phosphor layer is too thin, the amount of injection of the sealing material is adjusted and increased in accordance with the amount of change. Alternatively, in the case when the amount of change in the light emission intensity of the light emitting apparatus to be inspected is a positive (plus) value, since this state means that the thickness of the phosphor layer is too thin, the amount of injection of the sealing material is adjusted and increased in accordance with the amount of change; in contrast, in the case when the amount of change is a negative value, since this state means that the thickness of the phosphor layer is too thick, the amount of injection of the sealing material is adjusted and reduced in accordance with the amount of change.

When, for example, an air dispenser is used, the adjustment of the amount of injection of the sealing material can be carried out by controlling the discharging pressure thereof. In this case, the relationships among the amount of change in the light-emitting area or the light emission intensity, the discharging pressure of the air dispenser and the amount of injection are preliminarily found by using a plurality of samples manufactured before the adjustment. As a result, the discharging pressure and the amount of injection can be controlled in accordance with the amount of change.

Moreover, as described above, since the precipitation of phosphor fine particles progresses in the sealing material inside the filling device, strictly speaking, the mixed ratio of the transparent resin and the phosphor fine particles in the sealing material thus injected (density of the phosphor particles) is slightly different depending on respective packages, and this also causes the difference in thickness and the difference in chromaticity of the phosphor layer.

Therefore, in the method for manufacturing the light emitting apparatus of the present invention, the density of the phosphor particles in the sealing material injected into the package is maintained at a predetermined density.

More specifically, by carrying out a stirring process, a circulating process, or both of these processes on the sealing material inside the syringe of, for example, an air dispenser, the density distribution of the phosphor particles is evenly maintained so that the density of the phosphor particles in the sealing material to be injected into each package can be maintained at a predetermined density. This process can be carried out by installing stirring blades to be driven in the syringe in the filling device, or by installing a circulating means for circulating the sealing material discharged from the lower portion of the syringe to be returned to the upper portion therein. In the present invention, not limited to an air dispenser, any filling device may be used as long as the sealing material is quantitatively extruded through pressure.

In this manner, in the injecting process, the amount of injection of the sealing material to be injected to each package is maintained at a predetermined amount, and the density distribution of the phosphor particles in the sealing material inside the filling device (in particular, near the discharging outlet) is evenly maintained so that the density of the phosphor particles in the sealing material injected into each package can be maintained at a predetermined density; thus, differences in thickness and differences in chromaticity of the phosphor layer of each of light emitting apparatuses consequently manufactured can be restrained.

Here, another method may be proposed in which selection is arbitrarily made from manufactured light emitting apparatuses, and the chromaticity of the selected apparatus is measured, and comparing the chromaticity of the selected apparatus with a reference chromaticity, the amount of injection of the sealing material is adjusted in accordance with an amount of change in the chromaticity. However, the chromaticity measurements are measurements that can be carried out after the resin has been cured, and an in-line feedback operation thereof is not available.

Moreover, still another method may be proposed in which the light emitting apparatus is cut into pieces to measure the thickness of the phosphor layer by using an optical microscope or the like; however, it is difficult to distinguish the border between the phosphor layer and the transparent resin layer, with the result that it tends to cause an error to find the value of the thickness of the phosphor layer, and the cut pieces of the light emitting apparatus have to be abandoned.

The present invention makes it possible to measure the light-emitting area or the light emission intensity of the phosphor layer in its in-line operation, with the injected sealing material being in an uncured state, to feed the measured values back to the injecting process, and also to stabilize the sealing material (amount of the phosphor) to be injected.

Referring to Drawings, the following description will discuss embodiments of the present invention.

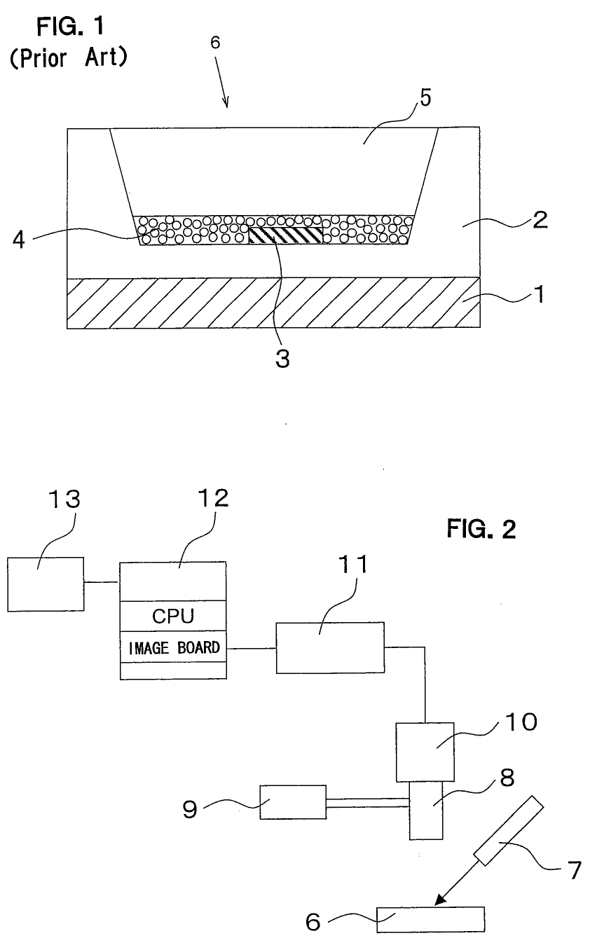

For example, a light emitting apparatus having a structure shown in FIG. 1 is listed as the light emitting apparatus relating to the present embodiment. Since the structure of this light emitting apparatus has been described above, the detailed explanation thereof is omitted.

FIG. 2 is a schematic drawing that shows a thickness-measuring system for a phosphor layer in accordance with the present embodiment. In this measuring system, a semiconductor line laser 7, which is arranged to apply laser light to a phosphor layer of a precipitation-type white LED 6 so as to enter the phosphor layer from diagonally above with a predetermined incident angle, is placed. This semiconductor line laser 7, which applies a linear laser light from a laser light releasing unit, may be used as, for example, a micro-line laser made by Takenaka Optonic Co., Ltd.

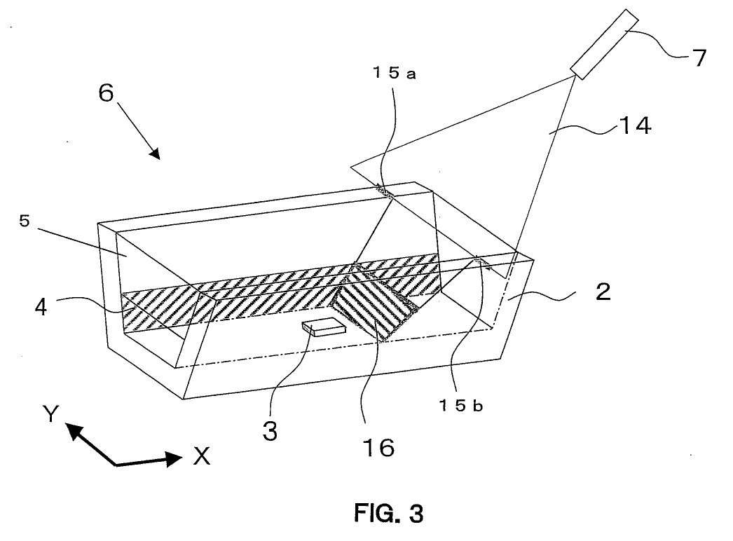

This semiconductor line laser 7 is secured at a predetermined angle by a holding means, not shown, is arranged to apply laser light over a range wider than the width of the transparent resin layer of the light emitting apparatus (see FIG. 3). Here, a direction of the width of the transparent resin layer is a direction practically perpendicular to the releasing direction of the laser light.

Moreover, above the white LED 6 in the direction perpendicular thereto, a monochrome image-pickup CCD camera 10 to which a fixed-magnification lens 8, with an even co-axial downward illuminating function, and a light source 9 are attached is placed in order to pick up an image on a plane of the fluorescence which is allowed to emit light by the yellow phosphor fine particles in the phosphor layer excited by the laser light. Here, for example, a halogen lamp may be used as the light source 9.

Here, a signal from the monochrome image-pickup CCD camera 10 is inputted to a processing device through a power source BOX 11 for a camera. This processing device is configured by a personal computer 12 provided with an image board and a central processing unit (CPU), a display 13 for displaying the final results, control information, and the like.

Image information, picked up by the monochrome image-pickup CCD 10, is taken out as binarized information, and subjected to image processing, such as expansion and contraction used for removing isolated black-color pixels and white-color pixels, as well as to data processing, such as standardizing process and smoothing process. Therefore, the light-emitting area and the emission intensity of the fluorescence of the phosphor layer can be finally found from the binarized data.

The following description will discuss a method for measuring the light-emitting area of the phosphor layer of the light-emitting apparatus by using the above-mentioned thickness-measuring system for a phosphor layer.

First, as shown in FIG. 3, from the semiconductor line laser 7 attached to the holding means (not shown) at a predetermined angle, the laser light 14 is applied to the white LED 6. At this time, as described above, some of the white LED's 6 have a structure, in which one or two wires are placed on the upper surface of a blue LED chip 3. In the case of the one wire, laser light is applied from a direction having no wire. Moreover, in the case of the two wires, laser light is applied from a direction having either one of the wires; however, since the wires are present on all the samples, the resulting condition is the same, and since the area of the wires can be eliminated by the image processing, no influences are given.

The laser light 14, released from the semiconductor line laser 7, is applied to the upper end face of the package 2 of the light-emitting apparatus, and refracted by and transmitted through the transparent resin layer 5 to enter the phosphor layer 4. The laser light 14, applied to the upper end face of the package 2, is reflected and confirmed as reflected light rays 15a and 15b, and the phosphor fine particles are excited by the laser light 14 entering the phosphor layer 4 to be allowed to emit light, so that fluorescence 16 is confirmed through the transparent resin layer 5. Here, the laser light 14 is reflected by the bottom face of the concave section of the package 2, and released to the outside through the phosphor layer 4 and the transparent resin layer 5.

In this case, the fluorescence 16, photographed by the monochrome image-pickup CCD camera 10, is image-processed by the personal computer 12. After that time, the fluorescence is displayed on the display 13 as if it emitted light in a plane state, when viewed in a direction perpendicular to the surface of the transparent resin layer. At this time, the laser light 14 is preferably applied thereto so as not comes into contact with the blue LED chip 3 so that the light-emitting area of the fluorescence 16 is located near the blue LED chip 3 other than an area right above the blue LED chip 3, when viewed in a direction perpendicular to the surface of the transparent resin layer. That is, the above-mentioned laser irradiation position is preferably used, from the viewpoint of determining the thickness of the phosphor layer 4 located near the blue LED chip 3 that gives great influences to the chromaticity of the light emitting apparatus.

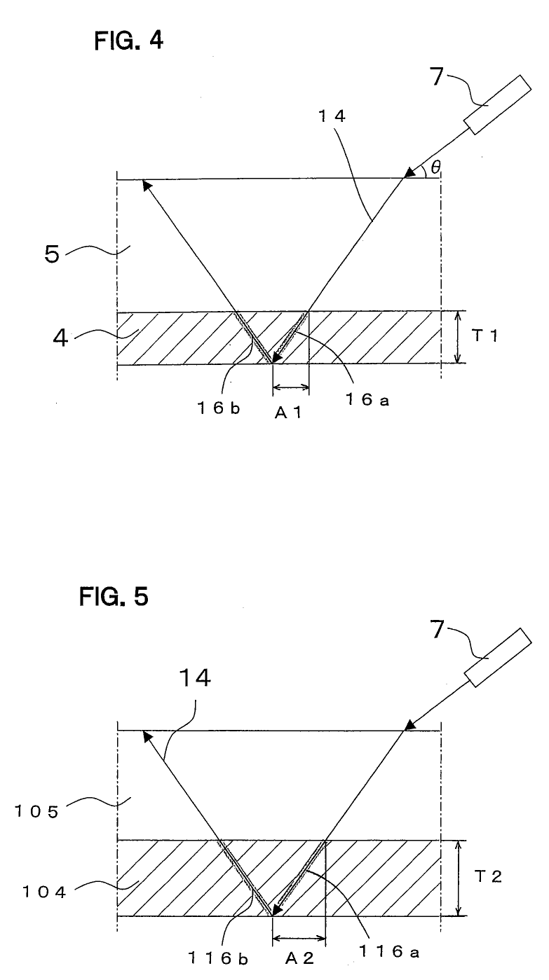

With respect to the incident angle θ (see FIG. 4) to the phosphor layer 4, any desired angle may be used as long as the angle allows the light-emitting area in its plane state to be confirmed. In the case when the incident angle θ is made smaller, the resolution is improved because of the longer distance in the phosphor layer 4 through which the laser light 14 passes; however, in the case when it is made too small, a problem arises in which the laser light 14 reflected by the bottom face of the package comes into contact with the blue LED chip 3. Moreover, in the case when the incident angle θ is made too large, a problem arises in which the semiconductor line laser 7 comes into contact with the CCD camera 10 to make measurements unavailable. For these reasons, the incident angle θ is preferably set to 55° or less, and is also made larger than an angle at which the laser light 14 reflected by the package bottom face is allowed to comes into contact with the blue LED chip 3 (for example, about 35°). Since reflected light rays 15a and 15b are used so as to determine reference places used upon measuring the fluorescence 16, both of the reflected light rays 15a and 15b and the fluorescence 16 can be confirmed when the incident angle θ is located within this angle range. Here, the incident angle θ is a value determined on the assumption that the refractive index of the transparent resin layer 5 is set to about 1.5.

Moreover, the wavelength of the laser light 14 is set so as to excite the phosphor fine particles, and set within a sensitivity range of the CCD camera 10, for example, in a range from 400 to 650 nm. Here, in the laser light 14, the beam diameter of a portion that enters the phosphor layer 4 is preferably made thinner since the thinner the beam diameter, the higher the vividness of the outline of the light-emitting area becomes, so that the measuring precision is improved; in contrast, the upper limit thereof is properly set to 25 μm. The beam diameter exceeding 25 μm is not preferable since this level makes the outline of the light-emitting area foggy to cause a reduction in the measuring precision of the light-emitting area.

FIG. 4 is a cross-sectional view (cross section in the X-direction) taken in a direction of the longer side of the package in FIG. 3. The laser light 14, applied to the white LED, is refracted by the transparent resin layer 5, and then enters the phosphor layer 4, and then reflected by the bottom face of the package, the laser light is allowed to pass through the phosphor layer 4 and the transparent resin layer 5, and discharged outside. Inside the phosphor layer 4, the phosphor fine particles, which have come into contact with the laser light 14, are excited to generate fluorescence 16a and 16b. At this time, suppose that the thickness of the phosphor layer 4 is T1 and that an entering distance of the laser light 14 that has entered the phosphor layer 4 is A1.

Here, in the case when, as shown in FIG. 5, a thickness T2 of the phosphor layer 104 is thicker than the thickness T1 of the phosphor layer 4 shown in FIG. 4, since the laser light 14 enters a phosphor layer 104 at a position closer to the semiconductor line laser 7 in comparison with the state shown in FIG. 4, an entering distance A2 of the laser light 14 that has proceeded into the phosphor layer 104 is longer than the entering distance A1 to generate the fluorescence 116a and 116b in this area of the entering distance A2.

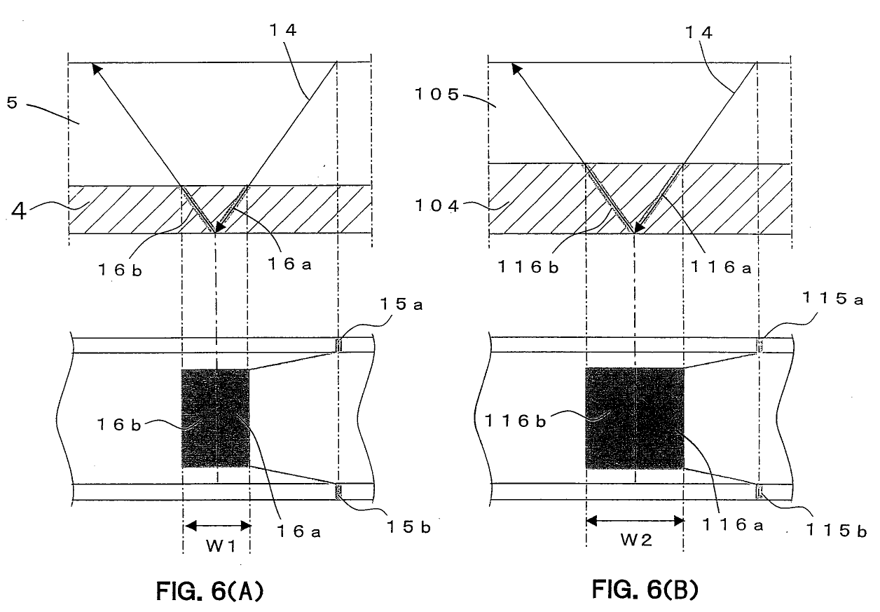

FIGS. 6A and 6B are conceptual drawings showing laser irradiation states shown in FIGS. 4 and 5, which are obtained by the monochrome image-pickup CCD camera 10 from above. In the case of FIG. 4, as shown in FIG. 6A, the reflected light rays 15a and 15b of the laser light 14, reflected by the upper end face of the package 2, and fluorescence 16a and 16b on the phosphor layer 4 can be confirmed. In the case of FIG. 5, as shown in FIG. 6B, reflected light rays 115a and 115b of the laser light 14, reflected by the upper end face of the package 2, and the fluorescence 116a and 116b on the phosphor layer 104 can be confirmed.

As shown in FIGS. 6A and 6B, when the entering distance of the laser light 14 is changed by the difference of thickness of the phosphor layer, a width W1 in the X-direction of the fluorescence 16a and 16b in the case of the thin phosphor layer 4 (FIG. 6A) and a width W2 of the fluorescence 116a and 116b in the case of the thick phosphor layer 104 (FIG. 6B) become different from each other, the latter width W2 becomes wider than the former width W1. Here, in FIG. 6B, reference numeral 105 represents a transparent resin layer.

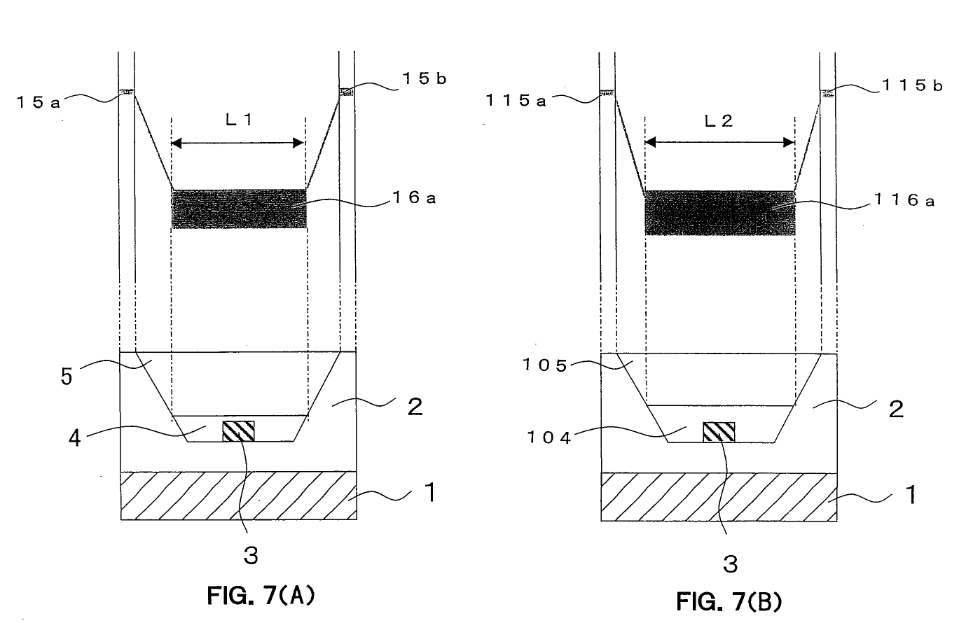

FIGS. 7A and 7B are conceptual drawings showing laser irradiation states shown in FIGS. 4 and 5, which are obtained by the monochrome image-pickup CCD camera 10 from above, and correspond to cross sections in the short side direction (Y-direction) of the package shown in FIG. 3.

As shown in FIGS. 7A and 7B, the cross section in the Y-direction of the package 2 has a cup shape with tapered faces on both of the sides of the concave section. For this reason, as shown in FIGS. 7A and 7B, when the thickness of the phosphor layer is changed, a length L1 of the fluorescence 16a and 16b in the case of the thin phosphor layer 4 (FIG. 7A) and a length L2 of the fluorescence 116a and 116b in the case of the thick phosphor layer 104 (FIG. 7B) become different from each other, the latter length L2 becomes longer than the former length L1.

As described above, when the phosphor layer 4 is thin, both of the width and the length of fluorescence become smaller in comparison with those of the thick layer. The values thereof increases as the phosphor layer 4 becomes thicker. Therefore, the light-emitting area (phosphor area) and the amount of change can be calculated based upon the width and the length of fluorescence in the phosphor layer of the reference light emitting apparatus and the phosphor layer of the light emitting apparatus to be inspected.

Here, the cross-sectional shape in the Y-direction of the package 2 may be prepared not as the above-mentioned tapered shape, but as a vertical shape.

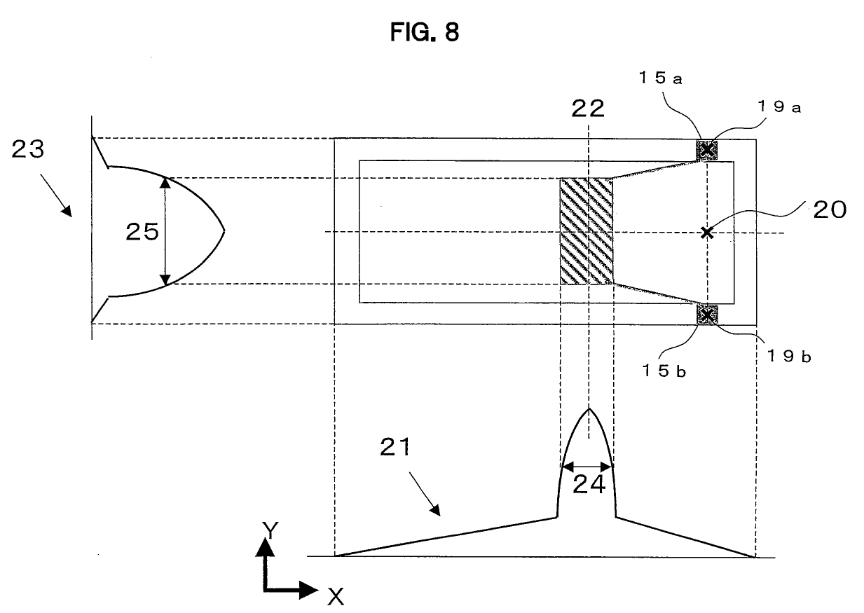

Referring to FIGS. 2 and 8, the following description will discuss a method for measuring the light-emitting area.

The image of the precipitation-type white LED 6 which has been picked up by the monochrome image-pickup CCD camera 10 is displayed on the display 13 having 511×479 pixels. First, binarized data of the reflected lights rays 15a and 15b picked up by the monochrome image-pickup CCD camera 10 are subjected to expansion and contraction image-processings in combination so that two centers of gravity 19a and 19b (middle position in the X-direction) are found, and center coordinates (x, y) 20 corresponding to the middle position of a line connecting the centers of gravity 19a and 19b are calculated. Here, the expansion in the image processing refers to a process in which, when even one 1 (white) is located near a certain pixel (near 4 or 8), the corresponding pixel is set to 1; in contrast, the contraction refers to a process in which, when even one 0 (black) is located near a certain pixel, the corresponding pixel is set to 0. When a contraction processing is carried out after an expansion processing, the corresponding image is made thicker by the expansion, and is also made thinner by the contraction, with the result that, although practically no changes are made, black isolated pixel portions are eliminated by the expansion processing. In contrast, when an expansion processing is carried out after a contraction processing, white isolated pixel portions are eliminated by the contraction processing.

Next, the binarized data of the center coordinates (x, y) 20 in the X-axis direction (xₙ, y)(n=0, 1, . . . 511) are read, and the binarized data, thus read, are subjected to a standardizing process and a smoothing process so that a waveform 21, as shown in FIG. 8, is obtained. Here, the binarized data to be read are not pixel data on only one line of the center coordinates (x, y) 20, but the average value of upper and lower several pixel data of the center coordinates (x, y), and the average values of the corresponding data are stored in the center coordinates (x, y). Thereafter, binarized data of the Y-axis direction (x, yₙ)(n=0, 1, . . . 479) relative to the coordinates (xₙ, yₙ) of the peak value of the waveform 21 are read, and the binarized data, thus read, are subjected to a standardizing process and a smoothing process in the same manner as in the X-axis so that a waveform 23, as shown in the left side of FIG. 8, is obtained. Here, the width of fluorescence, defined in FIGS. 6A and 6B, is calculated as a half-value width 24 of the waveform 21. Moreover, the length of fluorescence, defined in FIGS. 7A and 7B, is calculated as a half-value width 25 of the waveform 23; thus, the light-emitting area is found from the product of both of the half-value widths 24 and 25.

### Example

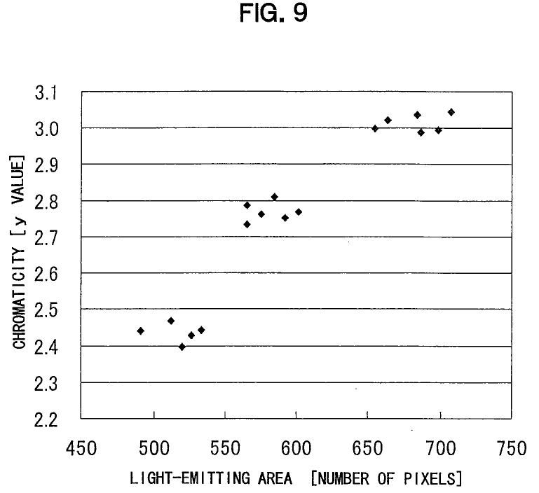

With respect to each of 17 precipitation-type white LED samples, the relationship between its chromaticity and the light-emitting area that is regarded as a thickness of a yellow phosphor layer is examined by using the above-mentioned method of the present invention, and the results thereof are shown as a graph in FIG. 9. The respective samples and measuring conditions, etc. are explained as follows:

White LED: YAG-based (Yttrium Aluminum Garnet) phosphor having an average primary particle size in a range from 10 to 13 μm, measured in its light-emission chromaticity upon application of 20 mA.

Semiconductor line laser: Micro-line laser made by Takenaka Optonic Co., Ltd.

Laser output value: application of 3.36V
Laser irradiation angle: 55°
Camera: CCD monochrome camera made by Toshiba Teli Corporation (spectral sensitivity: near 500 nm), used with its AGC (auto-gain control) function being turned OFF so as to remarkably confirm a change in amount of incident light.

Fixed magnifying lens with an even co-axial downward illuminating function: 4 times
Chromaticity-measuring device: LED tester (manual device) made by Teknologue Co., Ltd. with a high-speed LED optical characteristic monitor LE-3400, made by Otsuka Electronics Co., Ltd., being attached thereto.

As shown in FIG. 9, in those samples having high chromaticity, the light-emitting area (unit: number of pixels) becomes larger, and in those samples having low chromaticity, the light-emitting area becomes smaller; thus, the correlation that the chromaticity is highly related to the thickness of the yellow phosphor layer has been confirmed. In other words, in accordance with the present invention, the thickness of the yellow phosphor layer required for target chromaticity can be confirmed. Therefore, it is possible to always maintain the thickness of the precipitated yellow phosphor layer within an appropriate range.

The thickness-measuring method for a phosphor layer of a light-emitting apparatus in accordance with the present invention is, in particular, desirably applied to a precipitation-type light-emitting apparatus in which a phosphor layer containing phosphor fine particles is placed on the periphery of a LED chip. Here, the combination of the kind of a light-emitting diode chip and the kind of phosphor fine particles are not particularly limited, and with respect to the phosphor particles, any of those particles may be used as long as they absorb one portion of the wavelength of light from the light-emitting diode chip and emit light having a different wavelength. At present, a precipitation-type white LED has been mainly used as the precipitation-type light-emitting device. In the precipitation-type white LED, for example, a blue LED chip and yellow phosphor fine particles that emit yellow light by absorbing blue light are combined with each other to emit white light, and the present invention is desirably used for determining the thickness of the yellow phosphor layer of such a precipitation-type white LED.

What is claimed is:

1. A method for determining a thickness of a phosphor layer of a device having the phosphor layer formed by dispersing phosphor particles in a transparent resin, comprising the step of:
applying laser light to the phosphor layer to determine the thickness of the phosphor layer based upon an area of a light emitting region or a light emission intensity of fluorescence excited from the phosphor particles by the laser light.

2. The method for determining a thickness of a phosphor layer according to claim 1, wherein the device is a light emitting apparatus including a package having a concave section, a light emitting diode chip placed on a bottom face of the concave section of the package and a sealing layer formed by injecting a sealing material prepared by mixing phosphor particles with a transparent resin into the concave section to be cured, the sealing layer being provided with the phosphor layer to be applied with the laser light, the phosphor layer covering the light-emitting diode chip and a transparent resin layer placed on the phosphor layer.

3. The method for determining a thickness of a phosphor layer according to claim 1, wherein a determination of the thickness of the phosphor layer is carried out by comparing the area of the light emitting region or the light emission intensity of an arbitrarily selected phosphor layer with the area of the light emitting region or the light emission intensity of a reference phosphor layer.

4. The method for determining a thickness of a phosphor layer according to claim 1, wherein the area of the light emitting region or the light emission intensity corresponds to an area of a light emitting region of fluorescence or a light emission intensity of the fluorescence, obtained by applying laser light to a surface of the phosphor layer diagonally from above, and viewed in a direction perpendicular to the surface of the phosphor layer.

5. The method for determining a thickness of a phosphor layer according to claim 1, wherein the area of the light emitting region or the light emission intensity is measured by an image-processing apparatus having an image-pickup apparatus, and a wavelength of the laser light is set to a sensitive wavelength of the image-pickup apparatus.

6. The method for determining a thickness of a phosphor layer according to claim 2, wherein the laser light has a laser light portion, which enters the phosphor layer, having a beam diameter of 25 μm or less, and is applied over a range wider than a width of the package in a direction practically orthogonal to an irradiation direction of the laser light.

7. The method for determining a thickness of a phosphor layer according to claim 2, wherein an incident angle θ of the laser light ° onto a surface of the transparent resin layer is set in a range of 0<θ<55.

8. The method for determining a thickness of a phosphor layer according to claim 2, wherein the laser light is applied to the phosphor layer without applying to the light emitting diode chip, and when viewed in a direction perpendicular to the surface of the transparent resin layer, the light emitting region is located at an area other than a position right above the light emitting diode chip, and is located near the light emitting diode chip.

9. The method for determining a thickness of a phosphor layer according to claim 2, wherein the light emitting diode chip is a blue light emitting diode chip and the phosphor particles are yellow phosphor particles.

10. A method for manufacturing a light emitting apparatus comprising the steps of:
placing a light emitting diode chip on a bottom face of a concave section of a package;
injecting a sealing material prepared by mixing phosphor particles with a transparent resin into the concave section; and
forming a sealing layer by curing the transparent resin with the phosphor particles in a precipitated state so as to completely cover the light emitting diode chip, wherein
by using the method for determining a thickness of the phosphor layer according to claim 2, an area of a light emitting region or a light emission intensity of each of phosphor layers of a reference light emitting apparatus having reference chromaticity and an arbitrarily selected light emitting apparatus to be inspected is measured,
an amount of change in the light emission area or the light emission intensity of the light emitting apparatus to be inspected relative to the light emission area or the light emission intensity of the reference light emitting apparatus is calculated; and
the amount of change is returned to the injecting step to adjust injecting conditions and subsequently adjust the amount of injection of the sealing material to be injected to the package, so that the thickness of the phosphor layer is adjusted so as to set the chromaticity of the light emitting apparatus to the reference chromaticity.

11. The method for manufacturing a light emitting apparatus according to claim 10, wherein in the injecting step, a density of the phosphor particles in the sealing material to be injected into the package is maintained at a predetermined density.

12. The method for manufacturing a light emitting apparatus according to claim 10, wherein the injecting step is carried out by injecting a sealing material into a package by using a dispenser and the injecting conditions include a discharging pressure of the dispenser.

13. The method for manufacturing a light emitting apparatus according to claim 12, wherein, in the case when the amount of change is smaller than a predetermined value, the amount of injection of the sealing material is adjusted to be increased by increasing the discharging pressure; in contrast, in the case when the amount of change is larger than the predetermined value, the amount of injection of the sealing material is adjusted to be reduced by reducing the discharging pressure.

14. The method for manufacturing a light emitting apparatus according to claim 12, wherein, by carrying out at least a stirring process or a circulating process on the sealing material in the dispenser, a density distribution of the phosphor particles is in the dispenser evenly maintained to maintain the density of the phosphor particles in the sealing material to be injected into a package at a predetermined density.
